(19) United States
(12) Patent Application Publication
(10) Pub. No.: US 2008/0118088 A1
(43) Pub. Date: May 22, 2008

(54) Audio system with output modules

(75) Inventors: Ernest Ketterer, Kinnelon, NJ (US); David Chambers, Monroe, NY (US)

Correspondence Address: COLLARD & ROE, P.C., 1077 Northern Boulevard, Roslyn, NY, 11576, US

(73) Assignee: Bogen Communications, Inc.

(21) Appl. No.: 12/009,118

(22) Filed: Jan. 16, 2008

Related U.S. Application Data
(63) Continuation-in-part of application No. 10/401,626, filed on Mar. 28, 2003, now abandoned.

(51) Int. Cl. H04B 1/00

(52) U.S. Cl. 381/119

(57) ABSTRACT

An audio system comprises an audio device having an output, at least one module bay, and a connector disposed within said module bay. There is at least one signal processing output module having a connector for connecting with the connector in the module bay when the signal processing output module is inserted in the module bay. The signal processing module has a signal processing circuit and the signal path through the audio device is interrupted and re-routed through the signal processing module when the module is installed in the audio device. The module may also have a dress panel with at least one input on the dress panel for connecting an input device to the signal processing module. This way, the signal processing modules do not occupy the available inputs of the audio device.

### CROSS REFERENCE TO RELATED APPLICATIONS

This application is a continuation-in-part of U.S. patent application Ser. No. 10/401,626, filed on Mar. 28, 2003.

### BACKGROUND OF THE INVENTION

1. Field of the Invention

This invention relates to an improved audio amplifier and mixer arrangement with modular inputs. More specifically, this invention relates to an audio amplifier wherein connections to output modules are made through an internal connector to allow flexibility in connection with the amplifier. The signal flow through the amplifier is reconfigured automatically when a module is installed.

2. The Prior Art

Several manufacturers have been making audio amplifiers and mixers with modular inputs for more than a decade. The use of a modular input audio device allows the user to configure the number and type of inputs available in a mixer or amplifier for the particular application. The desire for modular inputs arises because there are several general categories of input devices that can be connected to an audio amplifier or mixer. Each of these input types requires specific electrical and functional characteristics of the device to which it is connected. Thus, the modular inputs allow a user to custom configure the inputs available on an audio amplifier or mixer to match the number and types of input devices to which it will be connected.

Many types of audio products could benefit from modular inputs. However, the typical usage is products that mix several inputs may or may not contain an integral power amplifier. Mechanically, the modules reside in a card cage that aligns the module and device connectors, allowing them to engage. A method for securing the modules, such as with screws, completes the assembly of the module into the audio device. Physically, these modules typically consist of connectors and controls that are mounted, or protrude, through a dress panel that covers the module bay opening when installed. The dress panel also provides a means of securing the module to the audio equipment.

A PCB (printed circuit board) is typically mounted on a right angle to the dress panel and contains a connector on the end, opposite the dress panel. The purpose of this connector is to electrically engage a mating connector on the audio equipment into which the module is being installed. The connector provides all of the necessary electrical connections between the module and audio equipment, including the power supply, for the module and audio signal paths. The internal connections from the module to the audio device have traditionally accommodated input signals that feed through the modules and into the audio device. Audio signals from the audio equipment connected back through the modules using these internal contacts has not been done before.

It is common for an audio system to require that the audio signal, within a piece of equipment, be processed in some manner. Typically this processing is performed at a point in the audio signal path where all input signals are combined, but before the signal exits the equipment for use or play by subsequent audio devices. It is also common for audio devices to provide a set of connectors that allows insertion of external equipment into the audio signal path at the point described above.

There are many terms used to describe this set of connectors but most commonly they are referred to as “inserts.” Inserts essentially consist of two connectors, one providing an output to the external equipment, and the other providing an input back into the audio device from the external equipment. When the inserts are not being used, they are shorted together to provide a continuous signal path. When desired, external signal processing equipment can be connected to the audio device's insert jacks. If more than one external signal processing device needs to be used in the audio system, then the various external audio devices need to be connected in series with one another. The input to the first external device in the series is connected to one of the insert connectors. The output from the last external device in the series is also connected to the other insert connector. Connecting more than one external signal-processing device to an audio device using its inserts could present numerous possibilities for misconnection or electrical incompatibilities of the separate equipment, and thus cause electrical problems. These misconnections and electrical incompatibilities can be a problem even if only one piece of external equipment is connected to the inserts, much less several.

The use of a module to provide signal processing as described above is well known. The current method requires the use of a pair of patch cables to make connection between the audio device's inserts and the complementary connectors on the dress panel of the module. Essentially, the modules manufactured by several companies act like external processing equipment and only make use of the internal power supply connections to supply voltage to the processing circuits, and the module bays as a mechanical mounting means.

These module types still require the use of external patch cords and device inserts to provide the signal paths to and from the audio processing circuitry. Many of these types of signal processing modules provide an input function as well, but this ability is a separate function from the signal processing.

The use of the external patch cords is undesirable from two standpoints. First, it is desirable to have the audio device's inserts available for use by other external equipment, and not to be consumed by one of the audio device's modules. As mentioned above, there is typically only one set of inserts on the audio equipment that accepts modular inputs. Once the insert is occupied, connection of any other equipment to these connection points becomes much more difficult. Secondly, this method of patch cord connection is prone to installation errors where input and output connections are reversed which can incapacitate, or damage the audio device or module. Likewise the connection method is vulnerable to accidental disconnection, which again can incapacitate the audio device.

### SUMMARY OF THE INVENTION

It is therefore an object of the invention to overcome the disadvantages of the prior art and provide a modular input audio device that performs the same function as the external equipment described above and yet leaves the audio device's inserts available for use by other external equipment. The invention improves the way in which the various and necessary audio connections are made to modules that provide signal processing functions by having the audio device actively detect the presence of the module and reroute the signal through the module when it is installed in the audio device.

Accordingly, the present invention provides an improvement for connecting signal processing modules. In this embodiment, the previous external connections are made through the internal connector. The invention modifies both the connections provided on the modules and the audio device into which the modules are installed. By moving the connections internally, the shortcomings of the prior art devices and method are overcome.

The internal signal structure of traditional audio equipment must be modified to make the audio equipment compatible with internal signal connections. The signal path that results when the individual input signals are combined is known as the mix bus. For the invention, it is necessary to provide a means to insert the proposed signal-processing module into the mix bus signal path. Electrically, there are numerous ways to accomplish this, but functionally it is accomplished the same way. To insert a signal processing circuit into a signal path, first the path must be broken and then the signal processing circuit's input and output must be connected to the proper ends of the broken path. This can be accomplished using many well known engineering methods. In a preferred embodiment, solid state analog switches are used for rerouting the audio signals for this purpose. When no output signal-processing module is installed, the audio device does not detect the presence of a module and keeps the switch closed. This allows the combined input signals from the input modules to pass to the internal amplifier or final output.

The audio device detects when a module is installed and reverses the state of the switch. This switch configuration breaks the previous signal path and reroutes the signal through the installed module's signal processing circuit. Again, this is one of many topologies that accomplish this same function. Module bays that can accept signal-processing modules can be created expressly for the use of these modules or the bays can be created to accept either input modules or signal processing modules. Also, there is no restriction, except for practicality, to the number of module bays that can accept signal-processing modules. As mentioned above, the compatible audio equipment must also be capable of detecting that a signal-processing module is installed. There are various ways of detecting the presence of a module. This is most easily done with an additional electrical connection on the module interface that actively signals the compatible audio equipment of the module's presence as soon as the module is installed. This additional electrical connection is an active connection that instantly detects the presence of the module when it is installed, and sends a signal to the device to notify the device of the installation. This is only one of many means for detecting the module's presence. Other means are through optical detection, magnetic detection or mechanically actuated detection. Alternatively, the detection could occur manually, such as through a manual switch that is installed in each bay of the audio device. The switch would be manually set to determine whether the bay is to accommodate a signal processing module or not. While the implementation of each of these methods is somewhat different, they are all well understood by people skilled in the art and accomplish the same task.

The method of detecting the module's presence and rerouting the signal path can be replicated for as many module bays as desired. In the case of multiple signal processing modules, each module is connected in series with other installed output signal processing modules, thereby compounding the effects of each module's signal processing. The order by which the output signal processing modules cascade is determined by the design of the signal path, but the most common sense approach is to have each output signal processing module interrupt the signal path between its neighboring modules.

The modules according to the invention require additional contacts on the connector to provide the necessary input and output connections for processing the audio signal. Additionally it must contain the means to signal the compatible audio equipment of its presence when installed. The present invention allows a signal to be routed from the audio device and back to it using internal connections or bypassing the routing in conjunction with a means to automatically determine the presence of a signal processing module.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a perspective view of the mechanical details of the invention;

FIG. 2 shows a block diagram of a system that has numerous module bays that can accept either input or signal processing modules;

FIG. 3 shows a block diagram of a detail of two module bays and signal-processing modules with signal flow arrows; and

FIG. 4 is a block diagram of the present invention with 8 total bays, two of which can accept signal processing modules as well as input modules.

### DETAILED DESCRIPTION OF THE PREFERRED EMBODIMENT

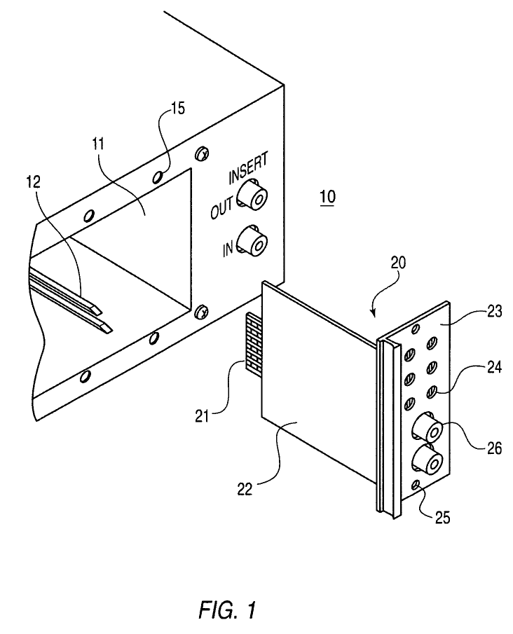

Referring now in detail to the drawings, FIG. 1 shows an audio device 10 having a module bay 11 and a signal processing module 20 according to the invention. Within module bay 11, there are guide tracks 12 to allow module 20 to be slid within bay 11 in an aligned manner. Module 20 has a connector 21 at one end of a PCB 22 for connecting to a connector (not shown) within audio device 10. At the other end of module 20 is a dress panel 23 having a series of input connectors 26 for allowing external devices to be connected to audio equipment 10 through module 20, as well as controls 24. Dress panel 23 also has screw holes 25 for attaching module 20 to audio device 10 via screws (not shown) and holes 15 in audio device 10.

Module 20 is a signal processing module and can be one of several different types. For example, module 20 could be a parametric equalizer module, having 4 bands with 2 mid bands of parametric equalization control with adjustments for filter bandwidth (“Q”), filter center frequency, cut or boost level, as well as cut or boost for bass and treble. Alternatively, the module could be a compressor/limiter, in which as a compressor minimizes the differences in level of all of the inputs on the mix bus, or as a limiter, keeps the overall output at a desired level. Or, the module could be an ambient noise sensor, which automatically adjusts the level of a page announcement or background music in an area where ambient noise levels are continuously changing. Other types of modules could also be used in the invention.

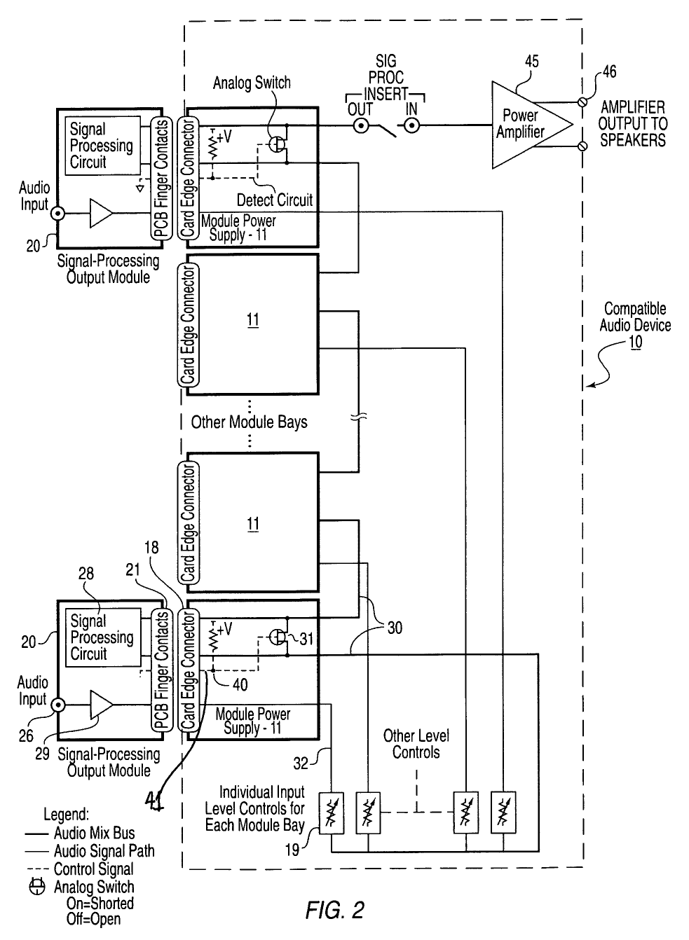

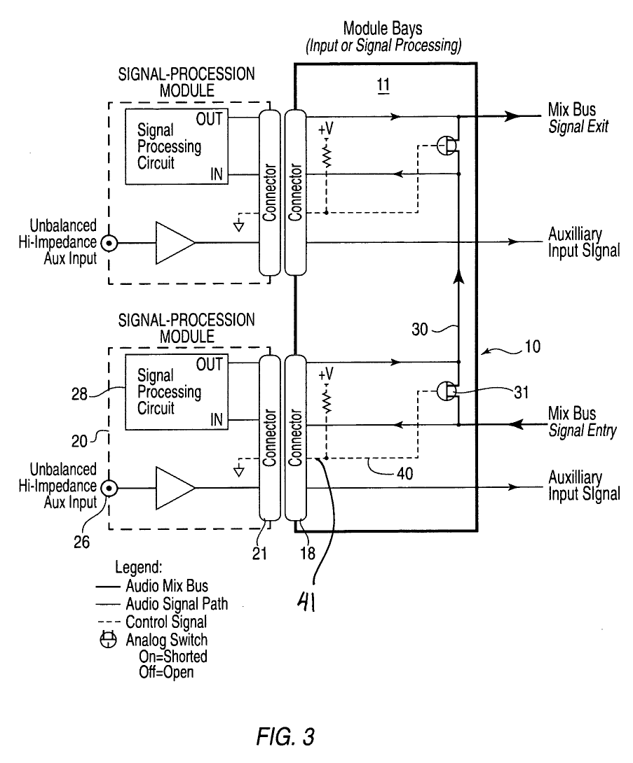

FIG. 2 is a block diagram of audio device 10 having two signal processing output modules 20 connected in two of four module bays 11. As shown by the break in FIG. 2, any number of bays and modules could be used within the space constraints of the audio device. FIG. 3 is an enlarged view of the two modules 20 and bays 11 showing the direction of the signal path via arrows. Module 20 is connected to device 10 via PCB finger connections 21 connecting to card edge connector 18 on device 10 in the manner described above with respect to FIG. 1. Module 20 has a signal processing circuit 28 which is connected through connectors 21 and 18 to an analog switch 31 which routes the signals through an audio mix bus circuit 30. When no module 20 is inserted into bay 11, switch 31 remains closed and allows the combined input signals from the input modules to pass to the internal amplifier and final output. When a module 20 is installed, device 10 detects its presence and opens switch 31 to reroute the signal through circuit 28 on module 20. Device 10 can detect the presence of module 20 in various ways. Preferably the detection is through an additional, independent electrical connection on the module interface that actively signals audio device 10 of module 20's presence through control signal 40. The additional electrical connection 41 is an active connection that sends control signal 40 to the device to notify the device of the module's presence upon insertion of the module. Other detection methods could also be used.

This separate detection of the presence of the module allows the audio signals to be processed independently of the step of module detection. The audio signal in the present invention does not flow through the contacts being used to sense the presence of the cartridge, since this sensing is done by a separate electrical connection. Therefore, there is no degradation of the quality of the audio signal due to oxidation and use from the insertion and removal of the modules.

An amplifier 29 is connected to input 26, which is then connected to input level controls 19 in device 10 through wires 32 and connectors 21, 18. Modules 20 are connected in series with all adjacent modules inserted in bays 11. In FIG. 2, the two unoccupied bays 11 could be configured to accept input devices, or additional signal processing output modules, or a module combining both input and signal processing functions. Modules 20 are connected to a power amplifier 45 within the audio device 10, and then to the output 46 to the speakers (not shown).

While FIG. 2 shows a device 10 having four module bays with 2 bays being used for signal-processing output modules 20, numerous signal processing output modules 20 could also be configured on a single audio device 10. Each module is connected in series with other modules via mix bus circuit 30 to compound the effects of the signal processing of each module. Each output module 20 interrupts the signal path between its neighboring modules.

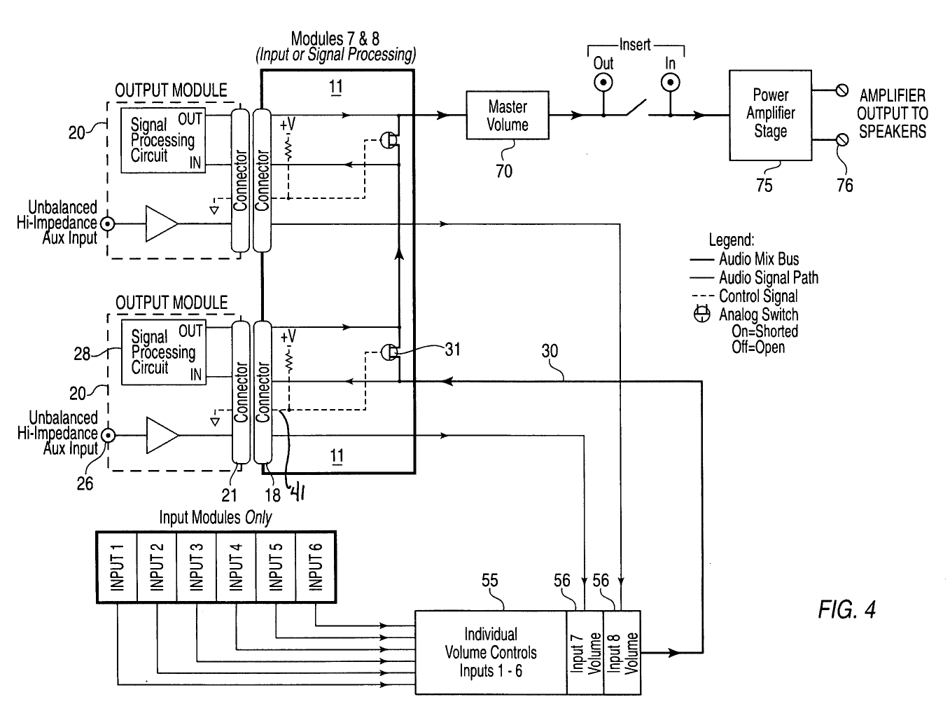

FIG. 4 shows a variation of the embodiment shown in FIG. 2, in that there are two signal processing output modules 20 and six input modules 50 connected to device 10. Each of modules 20, 50 has a separate volume control 55, 56 respectively. Modules 20, 50 are combined together onto mix bus circuit 30 through a master volume 70, an optional insert circuit 78, a power amplifier stage 75 and the amplifier output 76, which is connected to speakers (not shown).

Accordingly, while only a few embodiments of the present invention have been shown and described, it is obvious that many changes and modifications may be made thereunto without departing from the spirit and scope of the invention.

What is claimed is:

1. An audio system comprising:
an audio device having an output, a plurality of module bays, and an internal connector disposed within each of said module bays;
a plurality of audio signal processing output modules, connected in series with each other, each having a connector for connecting with the internal connector in the module bays when one of said signal processing output modules is inserted in one of said module bays; each of said signal processing modules having a signal processing circuit and the audio device having a signal path that is interrupted and re-routed through each of said the signal processing output modules when said modules are installed in said module bays; and
an additional electrical connection on a module interface for signaling the presence of at least one of said signal processing output modules when at least one of said signal processing output modules is installed in one of said module bays, said additional electrical connection actively sending a signal to the audio device upon installation of one of said modules to notify the device of the module's presence to cause the signal path interruption and re-routing through the module;
wherein effects of the modules are compounded via connection of said modules to an audio mix bus circuit in the device.

2. The audio system according to claim 1, wherein the module bays are adapted to accept both signal processing output modules and input modules.

3. The audio system according to claim 1, wherein there are at least four module bays.

4. The audio system according to claim 1, wherein at least one of the signal processing output modules is of a type selected from the group consisting of parametric equalizer module, a compressor/limiter and an ambient noise sensor.

5. The audio system according to claim 1, wherein at least one of the signal processing output modules has a dress panel with at least one input on said dress panel for connecting an input device to said signal processing output module.

6. The audio system according to claim 1, further comprising guide tracks disposed in at least one of said module bays for guiding at least one module into said at least one module bay.
